(19) United States
(12) Patent Application Publication
(10) Pub. No.: US 2002/0143899 A1
(43) Pub. Date: Oct. 3, 2002

(54) Providing access to present and past digital artefacts

(76) Inventor: Antonio Di Perna, Santa Barbara, CA (US)

Correspondence Address: ERICSSON RESEARCH CANADA, 8400 DECARIE BLVD., MONTREAL, QC, H4P 2N2, CA

(21) Appl. No.: 09/820,831

(22) Filed: Mar. 30, 2001

(51) Int. Cl. G06F 15/16

(52) U.S. Cl. 709/219

(57) ABSTRACT

The invention relates to a way of retrieving digital artefacts, such as web pages, from the Internet. A user may add to the address of the digital artefact for example a date indicating that he wants to access the digital artefact that was active on that date. This information is sent to the server that analyses the request to find out which version of the digital artefact that was used on that date. The server further retrieves the digital artefact and sends it to the users application program. The invention provides a method, a system, a server, and an application program for doing this.

### BACKGROUND OF THE INVENTION

1. Technical Field of the Invention

The present invention relates to retrieval of digital artefacts located in computer networks, such as the Internet, and more particularly to retrieval of information from web pages that are no longer active or that are active but only present a static view of the current instance of a web page or web site.

2. Description of Related Art

The Internet is a well-known phenomenon used by millions of people every day. FIG. 1 shows a simplified block diagram of an exemplary network-browsing environment according to the Prior Art. Only those items needed for explanatory reasons are included in FIG. 1, but it should be understood that a real network is bound to comprise more nodes, connections and the like. A user desiring to access a digital artefact, such as for example a document, an executable file, a picture file, a sound file, or an exemplary web page 11 (also known as a document) located on the Internet 20 needs some kind of application program 10 to do so. Such an application program 10 may be a program residing in some device (not shown) such as for example a computer, a cellular telephone or a Personal Digital Assistant (PDA).

In the description hereinafter, “web page 11”(or 11′ or 11″ as the case may be) may, where no risk of confusion exists, be used to describe the page as it is stored on a web site, the information, i.e. the HTML code, the executable files and so on, that make up the information in the page, and the web page as it appears to a user in a application program window. A person skilled in the art will certainly know what the term refers to at different times.

As is well known in the art, the user enters in the application program 10 a Uniform Resource Locator (URL) or the like that identifies the desired web page 11. The application program 10 sends a request comprising the URL towards an interconnecting network 17 through connection 19. This connection 19 may for example be electrical or optical connections or telephone cable connections. The connection 19 may also be a wireless connection using for example, but not limited to, one or more of the following technologies well known in the art: Time Division Multiple Access (TDMA), Code Division Multiple Access (CDMA), Wideband Code Division Multiple Access (WCDMA), Global System for Mobile Communication (GSM), Personal Digital Cellular (PDC), Total Access Cellular System (TACS), Code Division Multiple Access One (CDMAOne), Code Division Multiple Access 2000 (CDMA2000), and Bluetooth.

The interconnecting network 17 then forwards the request to the server 12 that will provide the web page 11. The connection 18 between the interconnecting network 17 and the server 12 may be of a kind mentioned hereinbefore. It is to be understood that the web page 11 need not reside within the server 12; it is sufficient if the server 12 has access to the web page 11 via a connection 13.

The server 12 then retrieves and sends the web page information through the interconnecting network 17 to the application program 10 that may process the web page information and present it so that the user can see, read and interact with it.

In the figure are also shown, as an example, two of the web page's 11 earlier versions 11′ and 11″. These earlier versions may often, as in this example, remain stored in a memory on, or accessible by, the server 12 but it is usually impossible to access them as there is no link pointing to them and as they in most cases have a name that is all but intuitive. This is indicated in FIG. 1 in that they are partially hidden by a more recent version.

While being easy to use in most cases, publishing web pages on the Internet (and other networks) does however present some problems.

One such problem stems from the fact that it is rare to use versioning tools when developing web sites. This means that it may very well be impossible, or at the very least very cumbersome, to re-build an older version of a web site once one or more files have been changed. In addition, in many cases versioning tools are only used during development, the use of those tools cease once the web site is up and running. For this reason, it is difficult to re-use material published on web sites.

Another such problem is that material published on the Internet tends to be ephemeral and often change without prior notice. A user that found interesting information in a web page and comes back later on to access the information once again may discover that the information is no longer to be found.

The present invention seeks to overcome the problems mentioned hereinbefore in providing methods, systems and network nodes that allow users to download a previous version of a web page and also to easily reconstruct a web site as it was at a certain occasion.

### SUMMARY OF THE INVENTION

The present invention is directed to a method for retrieving a digital artefact in a network comprising a server and an application program. The server comprises a profiler and has access to several digital artefacts. The server requests from the profiler an identity of a digital artefact corresponding to a digital artefact identifier and the associated version identifier. Upon reception of a response comprising the identity of the digital artefact from the profiler, the digital artefact is retrieved and sent to the application program.

The present invention is further directed to a system for retrieving a digital artefact in a network. The system comprises a server, a memory storing digital artefacts, and an application program. The application program sends to the server a request message comprising a digital artefact identifier and a version identifier associated with the digital artefact. The application program also receives at least one digital artefact from the server. The server comprises a communication unit for receiving from the application program a service request comprising a digital artefact identifier and a version identifier, and sending the at least one retrieved digital artefact to the application program. The server further comprises a profiler for providing a digital artefact identity corresponding to the version identifier, and a controller for retrieving from the memory the digital artefact corresponding to the digital artefact identity and for requesting from the profiler the digital artefact identity corresponding to the version identifier.

The present invention is further directed to a server for retrieving and delivering a digital artefact in a network comprising the server, a memory storing digital artefacts, and an application program. The server comprises a communication unit for receiving from the application program a service request comprising an address associated with a digital artefact and a version identifier, and sending the at least one retrieved digital artefact to the application program. The server further comprises a profiler for a digital artefact identity corresponding to the version identifier, and a controller for retrieving from the memory the digital artefact corresponding to the digital artefact identity and for requesting from the profiler the digital artefact identity corresponding to the version identifier.

The present invention is further directed to an application program for retrieving a digital artefact in a network comprising a server, and a memory storing digital artefacts. The application program is for sending to the server a request message comprising a digital artefact identifier and a version identifier associated with the digital artefact, and receiving at least one digital artefact from the server.

### BRIEF DESCRIPTION OF THE DRAWINGS

A more complete understanding of the present invention may be had by reference to the following Detailed Description when taken in conjunction with the accompanying drawings wherein:

FIG. 1 shown hereinbefore depicts a simplified block diagram of an exemplary network-browsing environment according to the Prior Art;

FIG. 2 depicts a simplified block diagram of a network-browsing environment according to a preferred embodiment of the invention; and

FIG. 3 depicts a flow chart of a preferred embodiment of a method according to the invention.

### DETAILED DESCRIPTION OF EMBODIMENTS

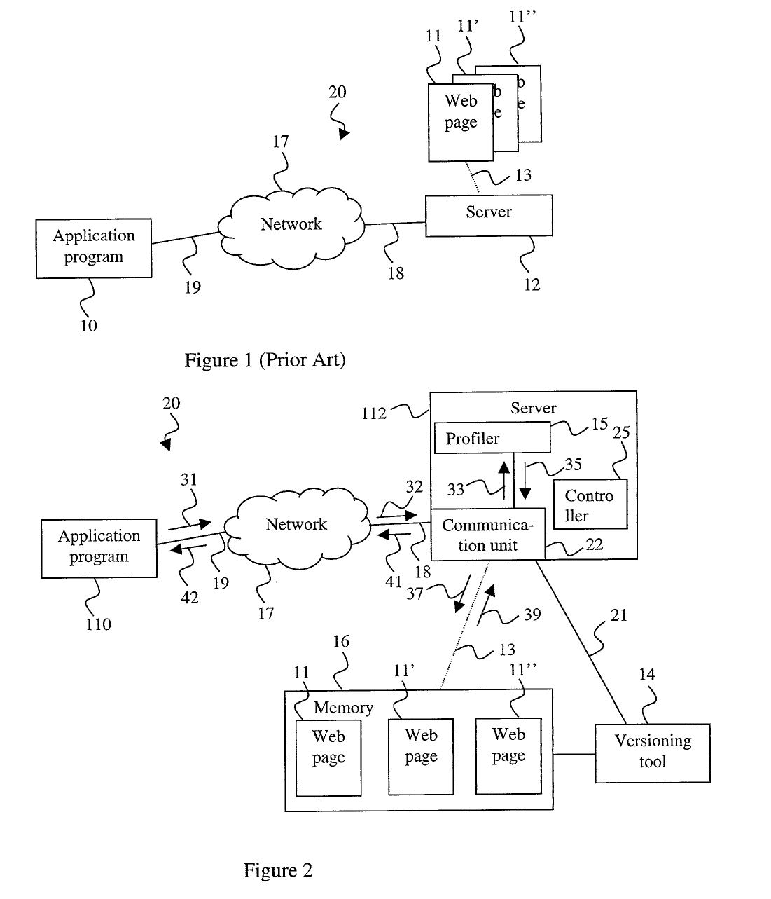

Reference is now made to the Drawings, where FIG. 2 depicts a simplified block diagram of an exemplary network-browsing environment according to an embodiment of the invention. Using the reference numbers from FIG. 1 where applicable, FIG. 2 shows a network 20, such as the Internet, comprising an application program 110, such as for example a network browser, that has a connection 19 to an interconnecting network 17. This interconnecting network 17 has a further connection 18 to a server 112, such as for example a content server. The server 112 comprises, or has access through connection 13 to, a memory 16 that stores several digital artefacts, the current version of a certain digital artefact 11, and two previous versions of the digital artefact 11′ and 11″. The server 112 further comprises a profiler 15, and has a connection 21 to or comprises a versioning tool 14. The versioning tool 14 keeps track of various versions of a certain digital artefact, such as a web page, by storing information on for instance the dates the certain digital artefact was used, i.e. when it was the current version of the digital artefact in question. The versioning tool 14 also uses concepts and conventions of labelling schemes that the profiler 15 will use to extract digital artefact versions associated to the defined label name rule, such as for instance 2001-01-31, as further described hereinafter.

According to the invention, a user that desires access to a certain version of a digital artefact enters the appropriate artefact identifier, such as for example a Uniform Resource Locator (URL) or Uniform Resource Identifier (URI) with an identifier of the desired version. This version identifier may be a suffix to the artefact identifier, for example in the form of a date. As an example, the user may enter: “http://www.siteaddress.com/2001-01-31”, which means that he desires to access the web page associated with www.siteaddress.com as it was on Jan. 31, 2001. The version identifier may have any practical form that uniquely identifies the version and that is understood by the participating parties; other examples comprise “2001/01/31”, “31_Jan_{—}2001” and “Jan_{—}31_{—}2001”.

The application program 110 then sends a service request message 31 towards the interconnecting network 17 where normally one or more routers (not shown) forwards the message and delivers it, possibly slightly changed (due to for instance added routing information) and delivers it to the server 112 as service request message 32.

Upon reception of the message 32 at the communication unit 22, the controller 25 in the server 112 analyses the artefact identifier. If the artefact identifier does not comprise a version identifier, then normal prior art procedures are used to retrieve the digital artefact. If however the digital artefact identifier comprises a version identifier, then a version query message 33, comprising the digital artefact identifier and the version identifier, is sent to the profiler 15 by the controller 25. Upon reception of the version query message 33, the profiler selects the one or more digital artefact that are associated with the identified version, such as for example the file or files that were used on the specific date, i.e. on Jan. 31, 2001 in this case. The profiler 15 returns the information, an exemplary response being digital artefact 11′, in a version response message 35, so that the controller 25 in the server 112 can retrieve the one or more right digital artefact (11′) from the memory 16. In case the memory 16 does not reside on the server 112, this can possibly be done by having the communication unit 22 send a retrieval request message 37 to the memory 16, that returns the one or more requested digital artefact (11′) in a retrieval response message 39. The retrieved digital artefacts (11′) are then sent in a service response message 41 towards the interconnecting network 17, that routes and forwards the message, possibly slightly changed (due to for instance added routing information), and delivers it to the application program 110 as service response message 42.

The application program 110 may then treat the digital artefact, for example by displaying the web page for the user to read and interact with. If the user then activates a link in the digital artefact 11′ then the application program 110 will try to retrieve and display the linked-to digital artefact as it was on the date previously given by the user. This may not always be possible, such as for example if the linked-to digital artefact resides on a web site that does not support retrieval of older versions of digital artefact.

To retrieve the right digital artefact, the server responding to the service request needs to know the version identifier associated with it. This can be achieved by the profiler 15 using a label rule which represents the suffix used in the artefact identifier that the profiler 15 then associates when extracting the digital artefacts and their respective versions that correspond to that service request 31. The server 112 responding to the service request 31 then sends the digital artefact to the application program 110 that for example may display the related digital artefact for the service request 31 and related digital artefact links that match the profiler rule specified in the initial service request 31.

The controller 25 in the server 112 may automatically add a version identifier to all the digital artefact identifiers found in the links in the requested digital artefact when responding to the service request. The application program 110 may keep a note of the version identifier associated with the retrieved digital artefact and automatically add the version identifier to any service requests originating from activated links in the displayed digital artefact.

The versioning tool 14 registers updates and changes to digital artefacts residing on, or associated with, the server 112. It also works with the profiler 15 (that it may be co-located with) in order for the latter to be able to respond to version query messages 33 with the correct information. This is done by attaching labels based on a label convention scheme to digital artefacts that are to be included on the server, for example in a web site. The profiler will later refer to the labels when a service request is submitted.

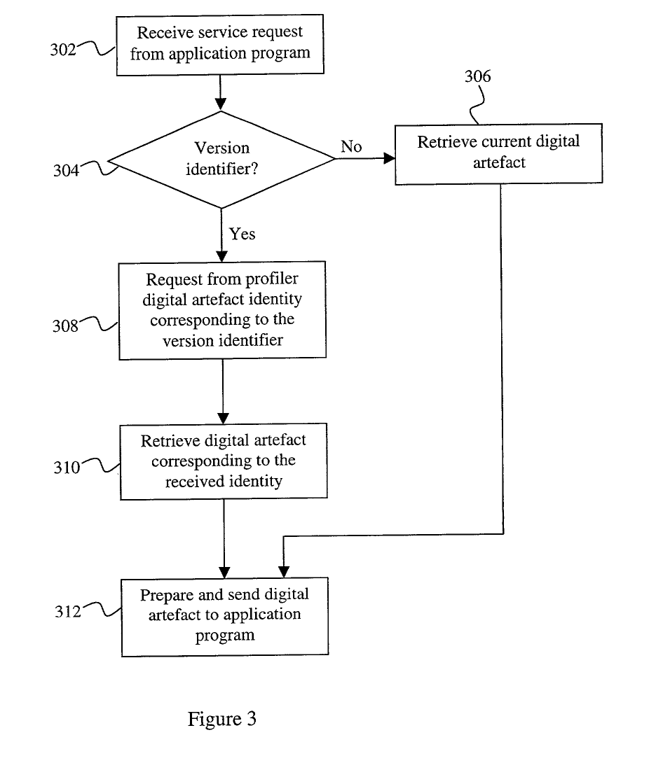

FIG. 3 shows a flow chart of a preferred embodiment of a method according to the invention. The steps of the method shown in FIG. 3 are the steps performed by the server 112.

In step 302 the server 112 receives a service request from the application program 110. The controller 25 verifies if the service request comprises a version identifier. If the service request does not comprise a version identifier, then the server 112 uses Prior Art techniques, i.e. retrieves the current digital artefact corresponding to the service request in step 306 and prepares and sends the digital artefact to the application program in step 312.

If the service request does comprise a version identifier, then the controller requests the digital artefact identity corresponding to the version identifier from the profiler 15 in step 308. Upon reception of the digital artefact identity, the controller 25 retrieves the digital artefact from the memory 16 in step 310. Finally, in step 312, the controller 25 prepares and sends, through the communication unit 22, the digital artefact to the application program 110.

Although several preferred embodiments of the methods, systems and nodes of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for retrieving a digital artefact in a network comprising a server and an application program, the server having access to several digital artefacts and the server further comprising a profiler, the method at the server comprising steps of:
requesting from the profiler an identity of a digital artefact corresponding to a digital artefact identifier and the associated version identifier;
upon reception from the profiler of a response comprising the identity of the digital artefact from the profiler, retrieving the digital artefact; and
sending the digital artefact to the application program.

2. The method according to claim 1, further comprising, prior to the step of requesting from the profiler an identity of the digital artefact, the step of:
receiving from the application program a service request comprising a digital artefact identifier and an associated version identifier.

3. The method according to claim 2, wherein a digital artefact has been received by the application program and a link in the received digital artefact has been activated, the method further comprising at the application program the step of:
associating the version identifier associated with the received digital artefact to the digital artefact corresponding to the activated link.

4. The method according to claim 1, wherein the version identifier is a date.

5. The method according to claim 1, wherein digital artefact is a web page.

6. The method according to claim 1, further comprising, before the step of sending the digital artefact to the application program, the step of:
adding the version identifier to all the links found in the received digital artefact.

7. A system for retrieving a digital artefact in a network, the system comprising a server, a memory storing digital artefacts, and an application program, wherein:
the application program is for:
sending to the server a request message comprising a digital artefact identifier and a version identifier associated with the digital artefact; and
receiving at least one digital artefact from the server; and
the server comprises:
a communication unit for
receiving from the application program a service request comprising a digital artefact identifier and a version identifier; and
sending the at least one retrieved digital artefact to the application program; and
a profiler for providing a digital artefact identity corresponding to the version identifier; and
a controller for:
retrieving from the memory the digital artefact corresponding to the digital artefact identity; and
requesting from the profiler the digital artefact identity corresponding to the version identifier.

8. The system according to claim 7, wherein the application program has received a digital artefact and a link in the received digital artefact has been activated, wherein the application program further is for associating the version identifier associated with the received digital artefact to the digital artefact corresponding to the activated link.

9. The system according to claim 7, where the controller further is for adding the version identifier to all the links found in the received digital artefact.

10. The system according to claim 7, wherein the application program is a network browser.

11. The system according to claim 7, wherein the profiler has a connection to a versioning tool.

12. A server for retrieving and delivering a digital artefact in a network, the network comprising the server, a memory storing digital artefacts, and an application program, wherein the server comprises:
a communication unit for:
receiving from the application program a service request comprising an address associated with a digital artefact and a version identifier; and
sending the at least one retrieved digital artefact to the application program; and
a profiler for a digital artefact identity corresponding to the version identifier; and
a controller for:
retrieving from the memory the digital artefact corresponding to the digital artefact identity; and
requesting from the profiler the digital artefact identity corresponding to the version identifier.

13. The server according to claim 12, where the controller further is for adding the version identifier to all the links found in the received digital artefact.

14. The server according to claim 12, wherein the profiler has a connection to a versioning tool.

15. An application program in a network, the application program being for retrieving a digital artefact in the network, the network further comprising a server, and a memory storing digital artefacts, wherein the application program is for:
sending to the server a request message comprising a digital artefact identifier and a version identifier associated with the digital artefact; and
receiving at least one digital artefact from the server.

16. The application program according to claim 15, wherein the application program has received a digital artefact and a link in the received digital artefact has been activated, wherein the application program further is for associating the version identifier associated with the received digital artefact to the digital artefact corresponding to the activated link.

17. The application program according to claim 15, wherein the application program is a network browser.
